(19) United States
(12) Patent Application Publication
(10) Pub. No.: US 2015/0232280 A1
(43) Pub. Date: Aug. 20, 2015

(54) Roof Mountable Support System

(71) Applicant: BULK SOLUTIONS PTY LTD, Burswood (AU)

(72) Inventor: Michael Pietsch, Burswood (AU)

(73) Assignee: BULK SOLUTIONS PTY LTD, Burswood (AU)

(21) Appl. No.: 14/426,722

(22) PCT Filed: Sep. 13, 2013
(86) PCT No.: PCT/AU2013/001048

§ 371 Date: Mar. 6, 2015

(30) Foreign Application Priority Data
Sep. 10, 2012 (AU) 2012903938

(51) Int. Cl. B65G 21/12; E21F 13/00; E21D 9/12

(52) U.S. Cl. CPC B65G 21/12; E21D 9/12; E21F 13/00

(57) ABSTRACT

A roof mountable support system (1) including a static element (2) arranged to be mounted to a roof of a tunnel or an underground mine and a mobile element (4). The static element (2) includes at least two tracks (8) on which the mobile element (4) is suspended for movement relative to the static element (2).

### FIELD OF THE INVENTION

The present invention relates to a roof mountable support system, such as a roof mounted support system to carry a conveyor used in an underground mine or a tunnel.

### BACKGROUND TO THE INVENTION

Underground coal mine drives and many civil tunnels are normally constructed by utilising machines such as continuous miners and road headers. These machines cut material at the face to a pre-determined dimension and advance forward. They can cut materials varying from relatively soft to medium hard rock. The cut material produced by the machines is normally carted away by wheel machines, such as a Load Haul Dump (LHD) or a shuttle car, which travel all the way to the mining machine to accept the cuttings produced and then cart them to their destinations. The tunnel or drive is therefore being constantly used with the haulage vehicles returning frequently. As the loaded vehicles are very heavy this action damages the tunnel roadway which often becomes boggy and unserviceable due to ground water intrusion.

Development production rates in mine drives and civil tunnels are affected adversely due to several factors. One of the most prominent factors is rapid floor deterioration. Rapid floor deterioration occurs most in cases where tunnel or drive construction is reliant upon mobile machines evacuating material from the face. Similar damage occurs in cases where Load Haul Dump (LHD) or shuttle cars are used in coal development or articulated trucks are used in tunnels.

This problem is particularly pronounced where ground water or dust suppression water accumulate in road depression inside a underground mine or civil tunnels. These areas are quickly turned into liquefied mud pools which get larger and deeper with every machine pass. The road to become boggy and deteriorates quickly with the heavy vehicles passing on the road frequently. Such conditions occur frequently and necessitate remedial work which is very time consuming causing the mining machine to stop production as it cannot dispose of the material produced when advancing the drive or tunnel. Remedial work necessitated lengthy production stoppages because it is extremely difficult to address the problem safely while the carting units are still operating.

The problem may be eliminated by promptly attending to various tasks such as better road forming and compacting including providing for water drainage and pumping sumps. However, this approach is not practicable because material produced by the face advance has to be evacuated by road travelling equipment. In addition, production work and mining operations would have to stop every few meters of advance in order to repair, shape, compact and stabilize the road before too much damage has occurred. Roadwork is difficult to be conducted while face mining is taking place as the haulage vehicles need to use the roadway to reach the mining machine. Such prompt actions would not only adversely impact production rates by slow progress to unacceptable levels but also increase production costs exponentially.

The roadway is quite narrow and the haulage equipment relatively large. The haulage equipment takes up much of the space of the roadway. Conducting mining and roadwork at the same time makes it extremely unsafe to place equipment and/or personnel on the roadway which is normally in the dark.

An alternative method to remove the mined material would be to adopt a belt conveyor system. Conventional conveyors consist of a rigid framework equipped with rollers supporting a reinforced rubber belt and equipped with a drive system to motivate the belt. Such a system needs to be rigid as it has to withstand the compressive forces exerted by the belt which needs to be substantially tensioned in order to cause friction and generate sufficient drive force out of the drive pulley which is usually placed at the head of the structure. Such structures are static and very rigid and normally rest on the floor. Supported on the floor, these conveyor belts mounted on a frame work occupy much of the space on the roadway. The access to the mine face for personnel and equipment is drastically reduced.

These belt conveyor systems may be suspended from the roof of a mine or tunnel. Prior art document U.S. Pat. No. 4,852,724 discloses such roof mounted conveyor belt. However, such a roof mounted conveyor belt is a fixed installation and does not have any way of travelling in order to follow the advancing face.

Prior art document US 2008/0066640 discloses a monorail system carrying hydraulic pipes and electric cables. However, it is incapable of transporting material.

With issues in known systems in mind, it is desirable of the present invention to provide an improved arrangement to facilitate a conveyor and/or ancillary services progressing into a tunnel or mine.

### SUMMARY OF THE INVENTION

With the aforementioned in view, an aspect of the present invention provides a roof mountable support system including a static element arranged to be mounted to a roof of a tunnel or an underground mine, and a mobile element, wherein the static element includes at least two laterally spaced tracks on which the mobile element is suspended for movement relative to and along the static element.

The term “roof” in this specification means the vault or ceiling of the tunnel or mine drive, whether natural rock/earth or the natural rock/earth covered with a form of protection, such as shotcrete or safety mesh.

The two track construction is able to carry a conveyor more efficiently, particularly when the tracks are arranged in a curved configuration.

The static element may be mounted to the roof by at least one fastening element. Preferably, the at least one fastening element includes a rock bolt pre- or post attached to the roof or a bolt anchored in the roof.

Rock bolts are generally mounted on the roof of an underground mine. These rock bolts could be readily used to mount the static element.

Preferably, the static element includes at least one cross member and at least one receiving element connected to a respective said cross member to secure the fastening element.

Preferably, the receiving element is positionable relative to the cross member to locate the fastening element. For example, the receiving element may be moveable along the cross member and/or perpendicular to the cross member in order to position it.

Locatable receiving means are particularly useful where (rock bolts mounted in the roof of an underground mine) are offset from each other.

Preferably, the system includes a plurality of cross members and a plurality of receiving elements.

The system may have at least one stabilising means to stabilise the static element relative to an uneven surface of the roof. The stabilising means may stabilise the system by being under compression or tension loading between the static element and the roof. The stabilising means may be adjustable in length and position to accommodate unevenness in the roof surface. This allows the system to provide a linear even path for the mobile element.

Preferably, the mobile element includes at least one arm. The at least one arm may be supported on a said track by means of at least one roller. Preferably, the mobile element includes a plurality of the arms. At least one of the arms may be pivotable at a pivot such that the pivoting movement compensates for misalignment between the static element and the mobile element.

Preferably, the mobile element moves relative to the static element either by manual force or by a self propelling means. The self propelling means may include a motor operated rack and pinion means.

The system may incorporate a conveyor, such as an endless belt conveyor, to carry materials along the system. The conveyor may include a traditional idler roller frame supported belt or a suspended (hanging belt), or supported tube type belt.

Preferably, the conveyor is mounted on the mobile element.

The conveyor is useful for transporting bulk material, such as from the mine face to a distant location.

As the mine face advances, static elements are further installed to extend the reach of the mobile elements carrying the conveyor. The static elements from the rear of the system may be attached at a front (nearer to the mine face) in order to recycle the static elements.

The system may support the conveyor, including the conveyor belt, its drive rollers/idlers/drum(s) and/or idler rollers/wheels.

Preferably, the conveyor is a trough conveyor, a conventional conveyor, a pouch conveyor or an enclosed conveyor.

Tension in the conveyor may be maintained without external tensioning means. This may be achieved by the support system supporting the conveyor or by providing its own tensioning system to the conveyor belt.

The support system may support a ventilation system, air pipe, electrical lines, piping, hoses, equipment and/or mine services.

Preferably, the system may be arranged to extend in a curved path in the horizontal plane and/or vertical plane. For example, one or more of the static elements may be curved and/or may have articulated connection to one or more adjacent said static elements.

Preferably, the system includes a plurality of the static elements, such that they form a support path or track.

The support system may be extended by connecting multiple said static elements linearly. For example, one or more said static elements may be connected to a first end of the system to extend the support system towards a work zone.

Preferably, one or more of the static elements may be removed from a second end of the support system and reconnected to the first end of the system to advance the support system into the tunnel or underground mine.

### BRIEF DESCRIPTION OF THE DRAWINGS

FIG. 1 illustrates a cross sectional end view of a roof mounted support system according to one embodiment of the present invention.

FIG. 2 illustrates a top view of a roof mounted support system according to one embodiment of the present invention.

FIG. 3 illustrates a cross sectional view of a roof mounted support system including a belt conveyor system according to one embodiment of the present invention.

FIG. 4 illustrates a cross sectional view of a roof mounted support system including a belt conveyor system without a belt according to one embodiment of the present invention.

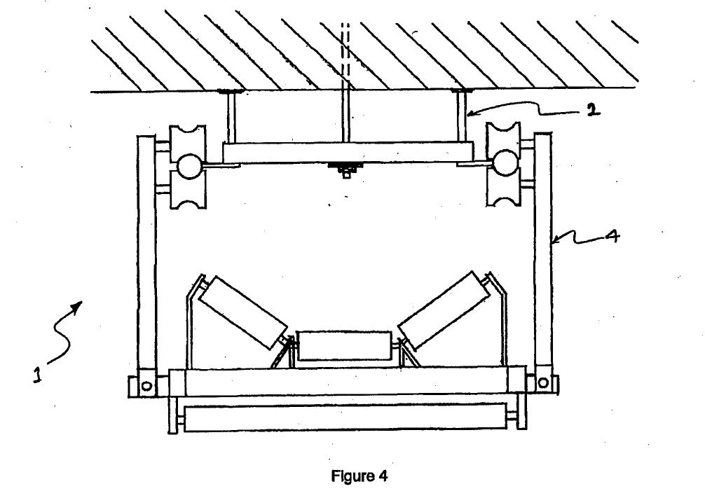

FIG. 5 illustrates a cross sectional view of a roof mounted support system including a belt conveyor system and an auxiliary attachment according to one embodiment of the present invention.

FIG. 6 illustrates a side view of a roof mounted support system according to one embodiment of the present invention.

FIG. 7 illustrates a top view of the tracks of a roof mounted support system according to one embodiment of the present invention.

FIG. 8 illustrates a perspective view of the static element of a roof mounted support system according to one embodiment of the present invention.

FIG. 9 illustrates a perspective view of the mobile element of a roof mounted support system according to one embodiment of the present invention, the mobile element carrying an enclosed conveyor (only a section of the enclosed conveyor is seen).

FIG. 10 illustrates a perspective view of the mobile element of FIG. 9 mounted on the tracks of a static element of FIG. 8.

FIG. 11 illustrates a top view of a roof mounted support system seen in FIG. 10.

FIG. 12 illustrates a cross-sectional end view of a roof mounted support system including an auxiliary attachment on one side of the system.

FIG. 13 illustrates a cross-sectional end view of a roof mounted support system including an auxiliary attachment on both sides of the system.

### DESCRIPTION OF PREFERRED EMBODIMENT

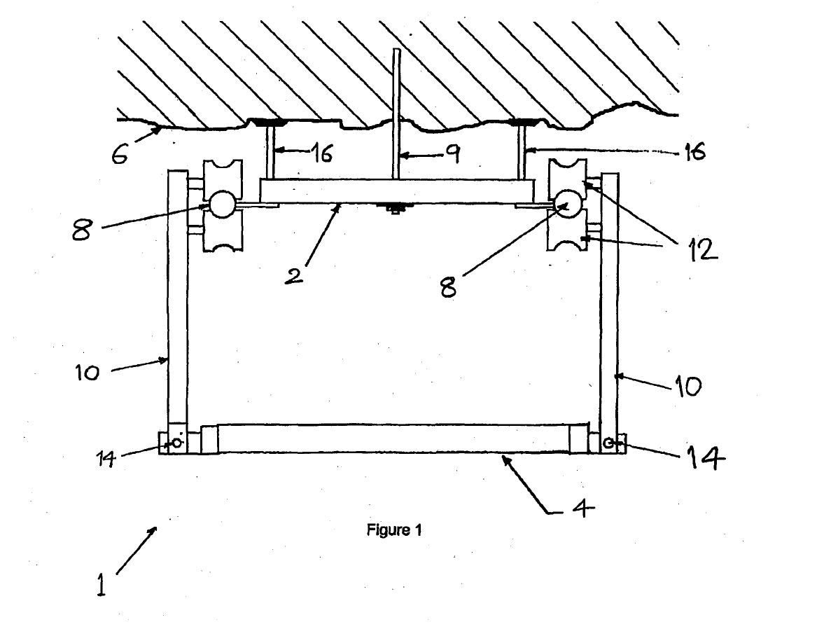

Referring to FIG. 1, the roof mountable support system 1 includes a static element 2 and a mobile element 4. The static element 2 is mounted to a roof 6 of a tunnel or an underground mine by means of a fastening element 9. The fastening element 9 is either a pre-attached rock bolt or a bolt anchored in the roof 6 prior to mounting the static element 2. The static element 2 includes a track 8 on either side. The track 8 is circular in cross-section and resembles a round pipe. However, it will be appreciated that other shapes of track may be utilised, such as square section or flat/angled rails. The mobile element 4 is suspended from the static element 2, such that it can move longitudinally relative to the static element 2. The mobile element 4 is in form of an articulated assembly of frames. The mobile element 4 includes two arms 10 supported on the static element 2 by rollers 12. At least one of the arms 10 is pivotable at the pivot point 14. The pivoting movement of at least one the arms 10 compensates for any misalignment between the static element 2 and the mobile element 4. The roof mountable support system 1 Includes stabilising means 16 positioned at intervals along the static element 2. The stabilising means 16 is tightened between the static element 2 and the roof 6, such that it is under compression loading. The stabilising means 16 act(s) to level the static element 2 relative to a next adjacent static element and/or relative to a desired height or level/incline. This may be achieved by jacking the stabilising means 16 to act directly or indirectly (such as through a packing piece) between the roof and the static element. The stabilising means can react the pull of the fastening element 9 or other fastening points to provide tension and thereby additional stability.

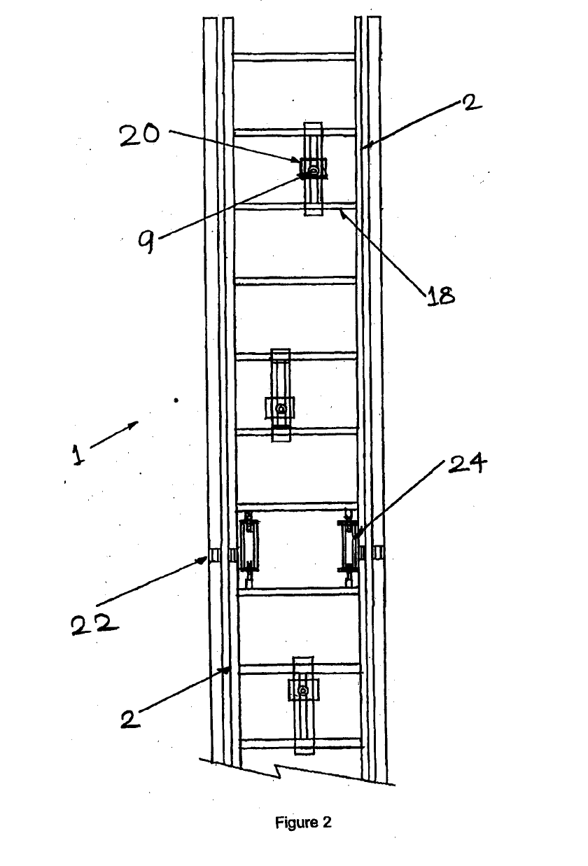

Referring to FIG. 2, the tracks 8 are connected via cross members 18 to form a ladder structure. The static element 2 includes a receiving means 20 attached to the cross member 18, such that the receiving means 20 can be moved parallel and perpendicular to the cross member 18. This movement of the receiving means 20 assists in locating the fastening means 8. This flexibility of the receiving means 20 allows the static element 2 to be mounted on the pre-attached rock bolts which may be at varying locations on the roof 6. This flexibility also avoids the need for extremely accurate positioning of fastening element 9. The ladder structure allows for receiving means 20 in the form of custom brackets to be used for connecting to the fastening element 9. However, fastening chains, rope or the like may also be used to secure the static element to the roof, instead of custom bracket. Also seen in FIG. 2 is one static element 2 connected to another static element 2 by means of a securing element 24. The securing element 24 holds the two static elements 2 together. The joining point 22 illustrates one static element 2 inserted into another static element 2 such that they form a continuous trail. The articulated form and the plurality of the static element 2 is seen in FIG. 2.

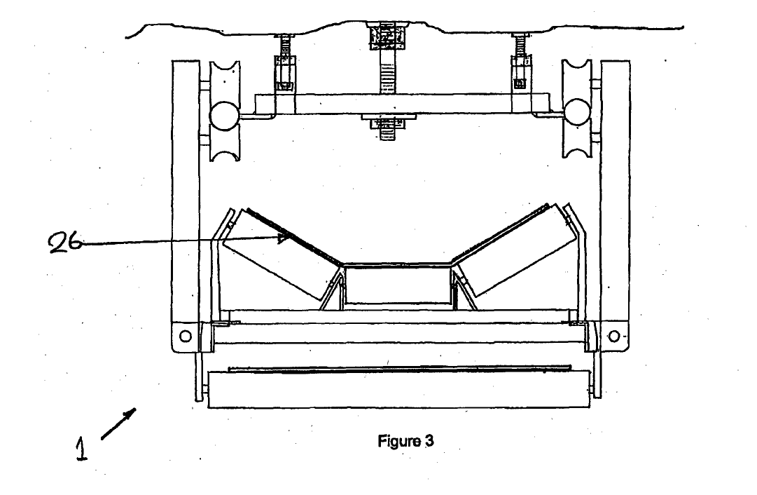

Referring to FIG. 3, the roof mountable support system 1 includes a belt conveyor 26 mounted on the mobile element 4. The belt conveyor 26 is used to transport materials from one end of the roof mountable support system 1 to another. For example, the conveyor 26 can transport materials from a work zone adjacent a first end of the support system towards a second end of the support system where the materials can be offloaded to a transport vehicle or further conveyor system.

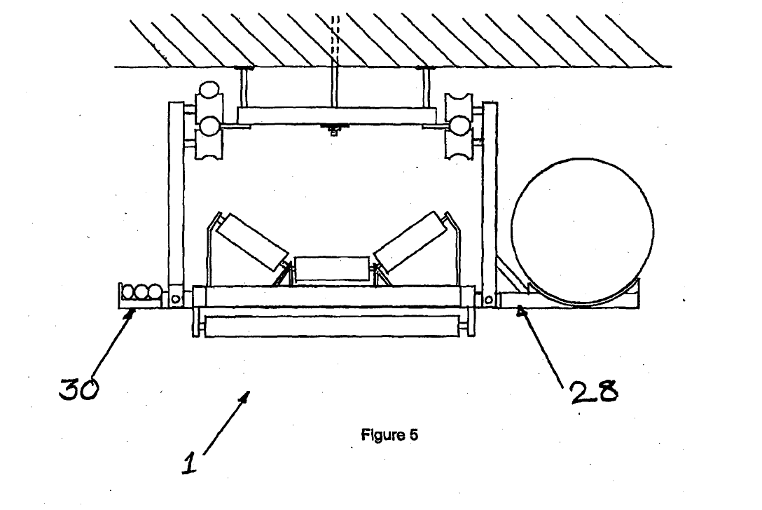

Referring to FIG. 5, the roof mountable support system 1 includes auxiliary attachments 28 and 30 on either side. Auxiliary attachment 28 supports an air ventilation apparatus, whereas auxiliary attachment 30 supports pipes, electrical cables, hoses, etc.

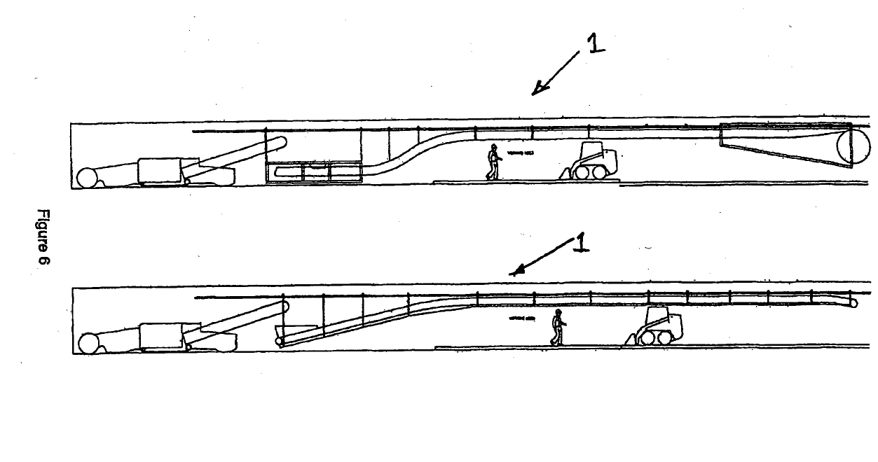

Referring to FIG. 6, the roof mountable support system 1 is extended in a curved path or a bent path in the vertical plane. Furthermore, the system 1 is mounted at a height such that personnel and certain machines are able to travel below the system 1. The static elements 2 nearer the min face are lowered so that the conveyor belt is lowered to carry the bulk material. There are illustrated two ways of lowering the system 1. In one embodiment, the system 1 is lowered linearly to the collection point such that the conveyor belt in inclined from the roof to a lower collection point. Alternatively, the system is lowered before the collection point such that the conveyor belt is able travel horizontally to carry bulk materials.

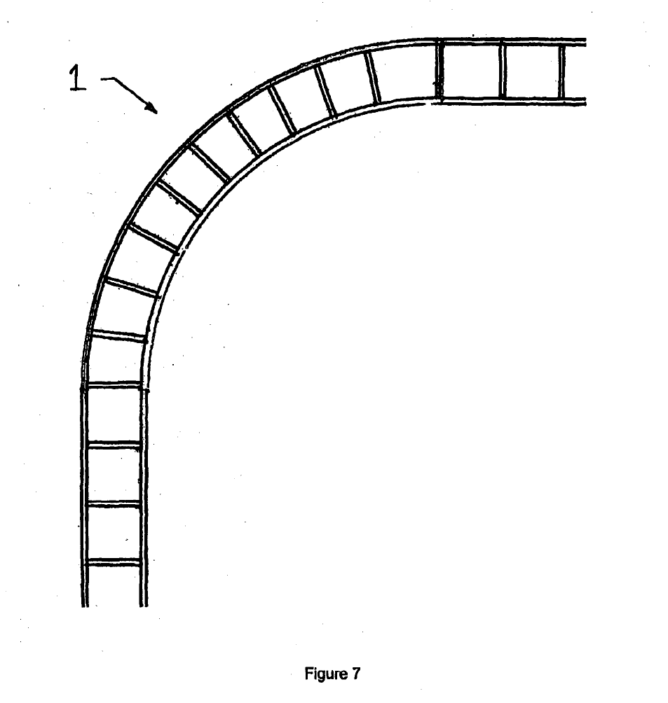

Referring to FIG. 7, the roof mountable support system 1 is extended in a curved path in the horizontal plane. Ideally the radius of the curved path is 6 meters. The two track construction is particularly beneficial for transporting the conveyor around a bend.

Tracks 8 may be equipped with a segmented strip. The strip forms a series of voids to enable a self propelling means to mesh in and utilise it similar to a rack and pinion assembly. The self propelling means includes a motorised rack and pinion arrangement.

In use, the static element 2 is mounted on the roof 6 by means of a fastening element 9. Stabilising means 16 are tightened between the static element 2 and the roof 6. Mobile element 4 is suspended from the static element 2. A conveyor 26 is mounted on the mobile element 4. Materials and equipment are transported along the conveyor 26. Auxiliary attachments 28 and 30 are connected to the mobile element 4. A ventilation system, air pipe, electrical lines, piping, hoses, equipment and/or mine services are supported on the auxiliary attachments 28 and 30. As mining commences and the mining face advances, the mobile element is moved nearer to the mine face. The mine services and equipment and material transport are available near the mine face, without damaging the floor. Once the mobile element 4 is moved so far that there is no static element 2 to suspend it, another static element 2 is attached to the roof mountable support system 1, so that the mobile element 4 can be moved closer to the mining face. Thus another static element 2 may be a new static element from the other end of the roof mountable support system 1. The static element 2 may thus be leap frogged to avoid unnecessary increase in inventory.

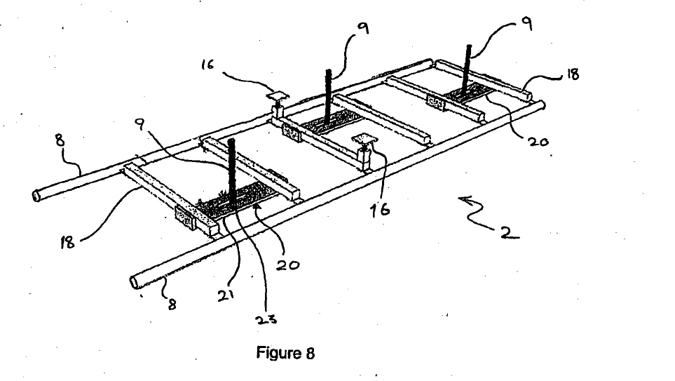

Referring to FIG. 8, the static element includes two tracks 8 joined by a plurality of cross-members 18. The receiving means 20 includes a bracket 21 mounted on the cross-members 18. The bracket 21 is moveable along the cross-members 18. The bracket 21 has an elongate aperture 23 through which the rock bolt 9 passes. The aperture 23 is elongate in a direction perpendicular to the cross members 18. The receiving means 20 is therefore locatable in two directions in order to receive the rock bolt 9. The first direction provided by the longitudinal movement of the bracket 21 relative to the cross-members 18. The second direction being provided by the elongate aperture 23 which is able to receive the bolt 9 at various lateral locations between cross-members 18. Therefore, the system 11 is able to accept rock bolts which are located offset to each other.

The stabilising means 16 have a plate attached at roof engaging end to provide larger surface area to engage with the roof. Larger surface area increases stability provided by the stabilising means 16.

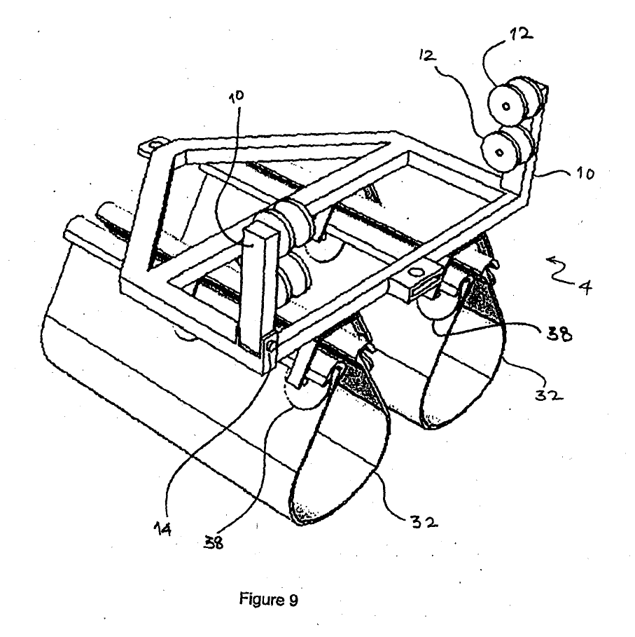

Referring to FIG. 9, the mobile element 4 has two rollers 12 mounted on each arm 10. The mobile element 4 carries an enclosed conveyor 32 via a plurality of idler rollers 38. There is a single enclosed conveyor 32 seen in FIG. 9. At one side, the enclosed conveyor 32 carries bulk material e.g. from the mine face for unloading, such as for transport away via a vehicle, whilst at the other side the enclosed conveyor 32 returns to the collection point at the mine face, such that the enclosed conveyor 32 travels in an endless loop.

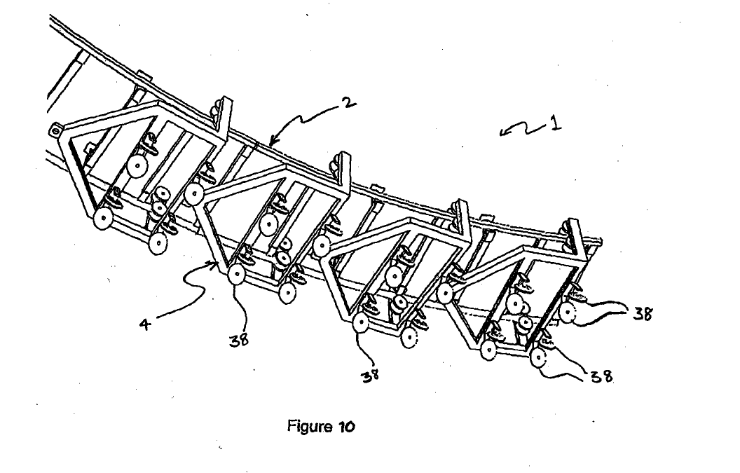

Referring to FIG. 10, a plurality of mobile elements 4 are shown suspended from a curved section of the static element 2. Each mobile element is attached to its adjacent mobile element 4 such that the plurality of mobile elements 4 form an articulated linkage of mobile elements 4. The mobile element 4 is pivotable with respect to the adjacent mobile element 4. This pivoting movement allows the mobile elements 4 to travel in a curved path following the curve of the extend of the static elements. Each mobile element 4 has idler rollers 38 attached to support an enclosed conveyor belt (not shown in FIG. 9).

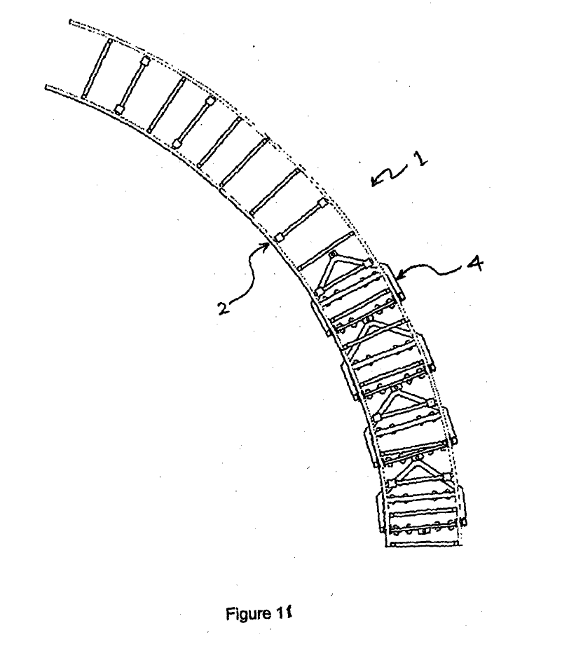

Referring to FIG. 11, the static elements 2 are mounted in a curved path. The articulated linkage of mobile elements 4 is moveable in the curved path because of the pivoting movement between the mobile elements 2. Therefore, a conveyor 32 supported by the mobile elements 4 can be transported around bends in an underground mine site.

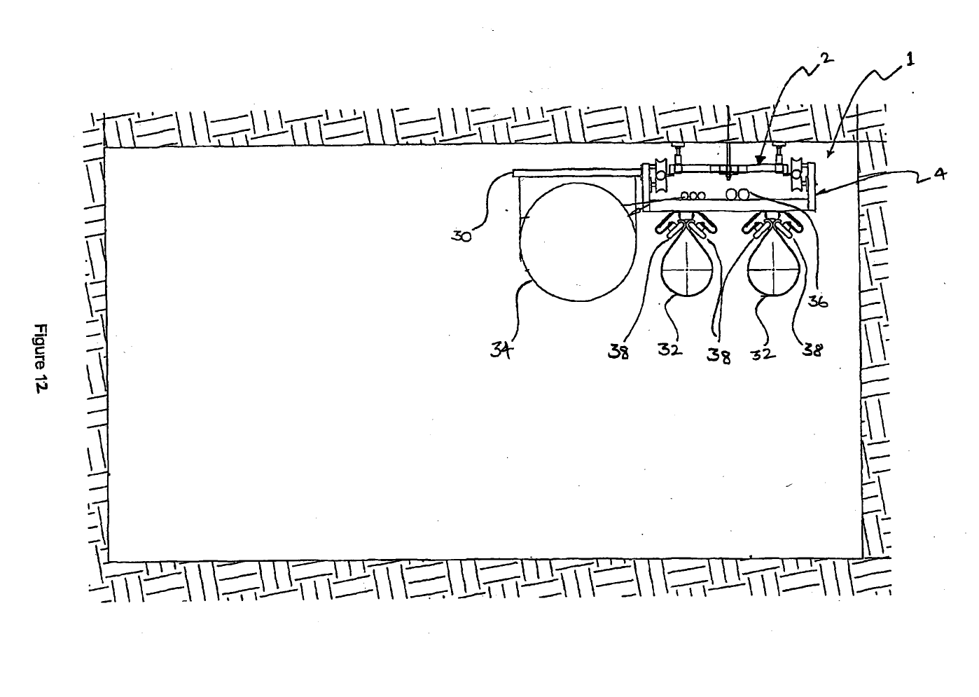

Referring to FIG. 12, the system 1 includes an auxiliary attachment 30 to carry a ventilation pipe 34. The ventilation pipe 34 is useful for supplying fresh air (oxygen) at the mine face. Services 36 such as pipes, electrical cables, etc. are placed on the mobile element 4. The services 36 and ventilations pipe 34 mounted on the mobile elements 4 travel with the mobile elements 4. Therefore, the services 36 and ventilation pipe 34 are proximate to the mine face as soon as the mobile elements 4 are moved proximate to the mine face. The system is mounted on a side of a tunnel in the underground mine such that there is room available on a side of the tunnel to transport items which would otherwise be difficult.

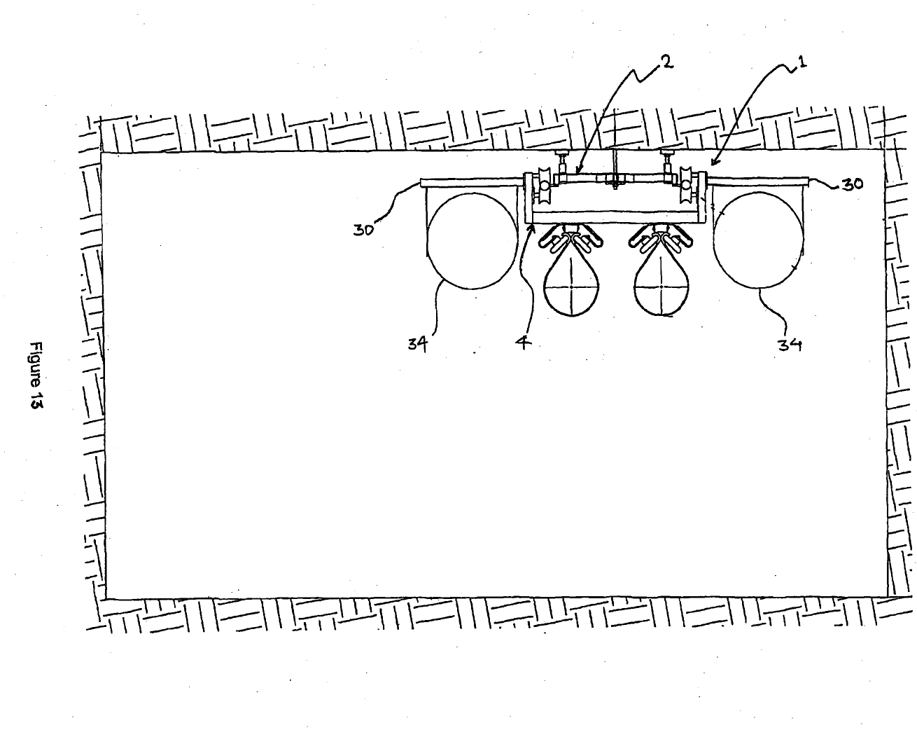

Referring to FIG. 13, in an alternative embodiment, there are two ventilation pipes 34 mounted on either side of the system 1. This embodiment is useful to transport higher volume of fresh air to the mine face.

The invention is not limited to the embodiments illustrated in the drawings but can be varied within the scope of the accompanying claims.

1. A roof mountable support system including a static element arranged to be mounted to a roof of a tunnel or an underground mine and a mobile element, wherein the static element includes at least two tracks on which the mobile element is suspended for movement relative to the static element.

2. The system according to claim 1, wherein the static element is mounted by means of at least one fastening element.

3. The system according to claim 2, wherein the at least one fastening element is a rock bolt pre-attached to the roof or a bolt anchored in the roof.

4. The system according to claim 3, wherein the static element includes a cross member and a receiving element mounted on the cross member to secure the fastening element.

5. The system according to claim 4, wherein the receiving element is moved along the cross member and/or perpendicular to the cross member in order to locate the fastening element.

6. The system according to claim 5, wherein the system includes plurality of cross members and a plurality of receiving elements.

7. The system according to claim 1, wherein the system has at least one stabilising means.

8. The system according to claim 7, wherein the stabilising means stabilises the system by being under compression loading between the static element and the roof.

9. The system according to claim 1, wherein the mobile element includes at least one arm.

10-24. (canceled)

25. The system according to claim 9,
wherein the at least one arm is supported on a said track by means at least one roller,
and/or
wherein the at least one arm is pivotable at a pivot such that the pivoting movement compensates for any misalignment between the static element and the mobile element.

26. The system according to claim 9, wherein the mobile element includes a plurality of the arms.

27. The system according to claim 1, wherein the mobile element moves relative to the static element either by manual force or by a self propelling means.

28. The system according to claim 27, wherein the self propelling means includes a motor operated rack and pinion means.

29. The system according to claim 1, wherein the system includes a conveyor to carry materials along the system.

30. The system according to claim 29,
wherein the conveyor is mounted on the mobile element,
and/or
wherein the conveyor is a trough conveyor, a conventional conveyor, a pouch conveyor or an enclosed conveyor,
and/or
wherein the tension in the conveyor is maintained without external tensioning means.

31. The system according to claim 1, wherein the system supports a ventilation system, air pipe, electrical lines, piping, hoses, equipment and/or mine services.

32. The system according to claim 1, wherein the system extends in a curved path in the horizontal plane, or the system extends in a curved path in the vertical plane.

33. The system according to claim 1, wherein the system includes a plurality of static elements, such that the plurality of static elements forms a trail.

34. The system according to claim 1, wherein the system is extended by attaching a second static element to the system at a first end of the system to be extended.

35. The system according to claim 34, wherein the second static element is a said static element detached from a second end of the system.
